(19) United States
(12) Patent Application Publication
(10) Pub. No.: US 2006/0287194 A1
(43) Pub. Date: Dec. 21, 2006

(54) Electrode for solid polymer type fuel cell and manufacturing method therefor

(75) Inventors: Kaoru Fukuda, Wako-shi (JP); Tadahiro Shiba, Wako-shi (JP); Yuichiro Sugiyama, Wako-shi (JP); Shinya Watanabe, Wako-shi (JP)

Correspondence Address: ARENT FOX PLLC, 1050 CONNECTICUT AVENUE, N.W., SUITE 400, WASHINGTON, DC, 20036, US

(73) Assignee: HONDA GIKEN KOGYO KABUSHIKI KAISHA

(21) Appl. No.: 11/508,958

(22) Filed: Aug. 24, 2006

Related U.S. Application Data
(62) Division of application No. 10/166,717, filed on Jun. 12, 2002.

(30) Foreign Application Priority Data
Jun. 13, 2001 (JP) 2001-179332
Jun. 13, 2001 (JP) 2001-179336
Jul. 18, 2001 (JP) 2001-218163
Jul. 19, 2001 (JP) 2001-219100
Jul. 19, 2001 (JP) 2001-219106
Jul. 19, 2001 (JP) 2001-219443

(51) Int. Cl. H01M 4/88

(52) U.S. Cl. 502/101

(57) ABSTRACT

An electrode for a solid polymer fuel cell, capable of enhancing the power generation efficiency without increasing the amount of catalyst carried on the carbon particles, is provided. Catalyst carrier particles having a catalyst substance 10 carried on the surface of electron conductive particles 1, and a polymer electrolyte containing catalyst having a catalyst substance 20 dispersed in an ion conductive polymer 2 coexist.

### CROSS-REFERENCE TO RELATED APPPLICATIONS

This is a Divisional Application, which claims the benefit of pending U.S. patent application Ser. No. 10/166,717, filed Jun. 12, 2002. The disclosure of the prior application is hereby incorporated herein in its entirety by reference.

### FIELD OF THE INVENTION

The present invention relates to an electrode for a solid polymer type fuel cell and to a manufacturing method therefor, and more particularly, relates to a technique for effective functioning of catalyst.

### BACKGROUND ART

A solid polymer type fuel cell is composed by laminating separators on both sides of a flat electrode structure. The electrode structure is a stacked element having a polymer electrolyte membrane held between a positive side electrode catalyst layer and a negative side electrode catalyst layer, with a gas diffusion layer laminated outside of each electrode catalyst layer. In such a fuel cell, for example, when hydrogen gas is supplied in a gas passage of the separator disposed at the negative electrode side, and an oxidizing gas is supplied in a gas passage of the separator disposed at the positive electrode side, an electrochemical reaction occurs, generating an electric current.

During operation of the fuel cell, the gas diffusion layer transmits the electrons generated by electrochemical reaction between the electrode catalyst layer and the separator, and diffuses the fuel gas and oxidizing gas at the same time. The negative side electrode catalyst layer induces a chemical reaction in the fuel gas to generate protons (H⁺) and electrons, and the positive side electrode catalyst layer generates water from oxygen, protons and electrons, and the electrolyte membrane transmits protons by ion transfer. As a result, electric power is drawn out through positive and negative electrode catalyst layers. Herein, the electrode catalyst layer is a catalyst paste mixed with carbon particles carrying catalyst particles such as Pt on the surface, and an electrolyte composed of ion conductive polymer, and this electrochemical reaction is believed to take place at the interface of three phases at which coexist catalyst, electrolyte, and gas.

However, in the catalyst paste prepared in the conventional process of mixing the carbon particles carrying the catalyst particles and an electrolyte composed of ion conductive polymer, the rate of utilization of catalyst ion particles in the electrochemical reaction tended to be low. Accordingly, the amount of carbon particles carrying catalyst particles had to be increased more than necessary, and since the catalyst particles are made of expensive noble metal such as Pt, the cost was greatly increased.

### DISCLOSURE OF THE INVENTION

It is hence an object of the invention to provide an electrode for a solid polymer type fuel cell capable of yielding high output and power generation at high efficiency without increasing the use of a catalyst substance, and to provide a manufacturing method therefor.

In a first aspect of the invention, the electrode for a solid polymer fuel cell comprises electron conductive particles having a catalyst substance A carried on the surface thereof, and an ion conductive polymer having a catalyst substance B dispersed in the polymer.

In a second aspect of the invention, the electrode for a solid polymer fuel cell relates to the first aspect, in which the average particle size of the catalyst substance A is larger than the average particle size of the catalyst substance B.

In a third aspect of the invention, the electrode for a solid polymer fuel cell relates to the second aspect, in which the catalyst substance B dispersed in the ion conductive polymer is characterized by mixing a catalyst precursor substance in the ion conductive polymer and reducing the catalyst precursor substance chemically, and the catalyst precursor substance is a mixture of a basic compound and a nonbasic compound.

In a fourth aspect of the invention, the electrode for a solid polymer fuel cell relates to the first aspect, in which the average particle size of the catalyst substance B is larger than the average particle size of the catalyst substance A.

In a fifth aspect of the invention, the electrode for a solid polymer fuel cell relates to the first aspect, in which the catalyst substance B has two kinds of average particle size.

A manufacturing method for an electrode for a solid polymer fuel cell of the invention comprises a step of preparing an electrode paste by mixing electron conductive particles having catalyst particles carried on the surface and an ion conductive polymer, a step of performing ion exchange from a catalyst metal ion to ion conductive polymer by treating this electrode paste or an electrode sheet prepared from the electrode sheet in a solution containing catalyst metal ions, and a step of reducing the catalyst metal ions.

Another manufacturing method for an electrode for a solid polymer fuel cell of the invention is characterized by mixing and reducing the catalyst precursor substance by dividing in two steps, in the manufacturing method for an electrode for a solid polymer fuel cell for preparing an electrode composition composed at least of an ion conductive polymer and a catalyst precursor substance, reducing the catalyst precursor substance to precipitate a catalyst substance B, and then forming this electrode composition into a sheet.

### BRIEF DESCRIPTION OF THE DRAWINGS

FIG. 1 is a conceptual diagram of an embodiment of an electrode for a solid polymer fuel cell of the invention.

FIG. 2 is a diagram showing the relationship of alkali addition rate in the ion conductive polymer mixed with the catalyst precursor substance and the viscosity of ion conductive polymer mixed with catalyst precursor substance.

FIG. 3 is a diagram showing the relationship of alkali addition rate and particle size of catalyst substance.

FIG. 4 is a diagram showing the relationship of coating rate of ion conductive polymer of electron conductive particles and the viscosity of the ion conductive polymer mixed with the catalyst precursor substance.

FIG. 5 is a conceptual diagram of another embodiment of an electrode for a solid polymer fuel cell of the invention.

FIG. 6 is a diagram showing the relationship of invasion depth of catalyst substance B dispersed in the ion conductive polymer and the surface resistance value of the plane of the electrode catalyst contacting with an electrolyte membrane.

FIG. 7 is a diagram showing the relationship of particle size of electron conductive particle (Pt particle) and surface resistance value.

FIG. 8 is a diagram showing invasion depth of catalyst substance B by varying the alkali addition rate in the ion conductive polymer mixed with the catalyst precursor substance.

FIG. 9 is a diagram showing the relationship of current density and voltage in a sample of a first preferred embodiment of the invention.

FIG. 10 is a diagram showing the relationship of platinum loading and voltage in the sample of the first preferred embodiment of the invention.

FIG. 11 is a diagram showing the relationship of current density and voltage in a sample of a second preferred embodiment of the invention.

FIG. 12 is a diagram showing the relationship of current density and voltage in a sample of a third preferred embodiment of the invention.

FIG. 13 is a diagram showing the relationship of current density and voltage in a sample of a fourth preferred embodiment of the invention.

FIG. 14 is a diagram showing the relationship of current density and voltage in a sample of a fifth preferred embodiment of the invention.

### BEST MODE FOR CARRYING OUT THE INVENTION

### (1) First Preferred Embodiment

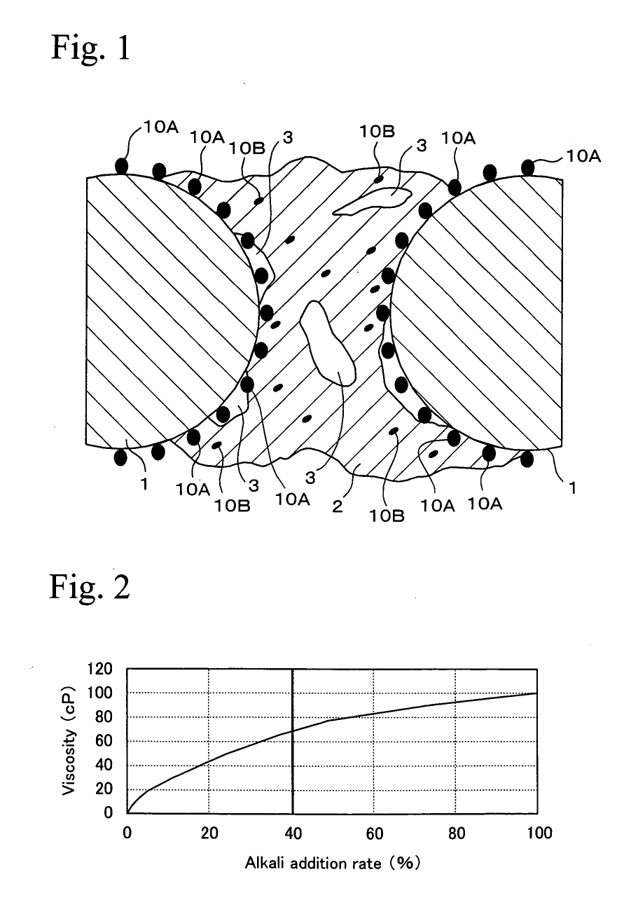

FIG. 1 is a conceptual diagram of first to third preferred embodiments of an electrode for a solid polymer fuel cell of the invention. As shown in the diagram, the electrode for a fuel cell of the invention is composed as a porous body having multiple pores 3, composed of, for example, electron conductive particles 1 and ion conductive polymer 2. Plural catalyst substances 10A are carried on the surface of the electron conductive particles 1, and a catalyst substance 10B is dispersed in the ion conductive polymer 2. As the electron conductive particles 1, for example, carbon black particles can be used, and as the ion conductive polymer 2, a fluoroplastic ion exchange resin may be used. As catalyst substances 10A and 10B, platinum group metals, such as platinum, palladium, can be used.

In the electrode shown in FIG. 1, fuel gas, such as hydrogen gas, passes through the pores 3, and is reduced by the action of the catalyst substance 10A, and protons and electrons are produced. This action is the same as in the conventional electrodes for fuel cells, however, the present inventors have discovered a similar action in the catalyst substance 10B dispersed in the ion conductive polymer 2. That is, when hydrogen gas comes into contact with the catalyst substance 10B near the surface of the electron conductive particles 1, protons and electrons are produced, and protons are conducted in the ion conductive polymer 2. Electrons are believed to propagate to the electron conductive particles 1 through the conduction network of the catalyst substance 10B. This is, however, only a hypothesis, and the invention is not limited to presence or absence of such action. To be near the surface of the electron conductive particles 1 means to be within 100 nm from the surface, and part of the catalyst substance 10B is estimated to be contacting with the electron conductive particles 1.

According to the research by the present inventors, it is known that the effect is obtained if the quantity of the catalyst substance 10B dispersed in the ion conductive polymer 2 is very small. That is, when a trace of catalyst substance 10B is dispersed in the ion conductive polymer 2, the power generation efficiency can be enhanced without increasing the amount of the catalyst substance 10A dispersed in the electron conductive particles 1.

Therefore, in the ion conductive polymer 2, preferably, the catalyst substance 10B should be dispersed uniformly, and in particular, it is more preferable when the catalyst substance is scattered about on the contact plane of the electron conductive particles 1 and ion conductive polymer 2 and its vicinity.

The catalyst substance A carried on the surface of the electron conductive particles is preferably affixed preliminarily on the surface of the conductive particles before mixing the electron conductive particles and ion conductive polymer. Furthermore, the catalyst substance scattered about on the contact plane of the electron conductive particles and ion conductive polymer and its vicinity is preferred to be composed of the catalyst substance A affixed preliminarily on the surface of the electron conductive particles before mixing the electron conductive particles and ion conductive polymer, and the catalyst substance B dispersed uniformly in the ion conductive polymer after mixing the electron conductive particles and ion conductive polymer.

The amount of the catalyst substance B dispersed in the ion conductive polymer is preferred to be 1 to 80% by weight of the total amount of the catalyst substances. If the amount of the catalyst substance B is less than 1% by weight, the activation overvoltage is too high, and the usable voltage is lowered, and it is difficult to obtain the advantage of presenting the catalyst substance by the catalyst carrier particles only. On the other hand, when the amount of the catalyst substance B dispersed in the ion conductive polymer exceeds 80% by weight, almost all of the catalyst substance is dispersed in the ion conductive polymer, and it is difficult to carry the catalyst substance amount necessary for power generation, in view of service life. For example, when the catalyst substance is introduced only by replacement and reduction of catalyst ions, the catalyst substance amount is determined by the ion exchange capacity of the ion conductive polymer; however, when increasing the catalyst substance, either replacement and reduction should be repeated, or the amount of the ion conductive polymer should be increased. In the former case, however, the particle size of the catalyst substance increases, or the gas dispersion in the electrode is lowered in the latter case. Preferably, the amount of catalyst substance B dispersed in the ion conductive polymer should be 3 to 50% by weight of the total amount of catalyst substances, and more preferably 3 to 20% by weight. Alternatively, by increasing the catalyst substance A carried on the electron conductive particles, the catalyst substance can be scattered about on the contact plane of the ion conductive polymer and electron conductive particles and its vicinity, and the utilization rate of the catalyst can be increased. Furthermore, by uniformly dispersing the catalyst substance B in the ion conductive polymer, an effective electron conduction network can be built up.

The invention is particularly effective when the specific surface area of the electron conductive particles exceeds 200 m²/g. That is, in electron conductive particles having such a large specific surface area, multiple fine pores are present on the surface, and the gas diffusion is excellent, and the catalyst substance existing in the fine pores does not come in contact with the ion conductive polymer, and hence does not contribute to reaction. In this respect, the catalyst substance B dispersed in the ion conductive polymer does not invade into the fine pores, and it is hence utilized effectively. That is, in the invention, while maintaining the reaction efficiency, the gas diffusion can be enhanced.

In contrast, the effect of the invention is also exhibited when the specific surface area of electron conductive particles is less than 200 m²/g. That is, when the specific surface area of electron conductive particles is small, the water repellent property is increased, and it is known that the gas diffusion of the ion conductive polymer is increased. In this case, however, the distance between two catalyst substances is short, which leads to other problems such as aggregation and sintering of catalyst substances as mentioned above. In this respect, in the invention, since it is not necessary to carry a large amount of catalyst substance on the electron conductive particles, such inconvenience can be avoided.

The ratio by weight of ion conductive polymer in electron conductive particles is preferred to be 1.2 or less. When the amount of the ion conductive polymer is small, the porosity increases and the gas diffusion is improved. On the other hand, the amount of the polymer electrolyte containing catalyst for covering the catalyst carrier particles decreases, and the activation point of fuel gas is lowered and the rate of utilization of catalyst substance drops. In this respect, in the invention, since the activation of fuel gas is compensated for by the presence of catalyst substance B contained in the polymer electrode containing catalyst, the activation overvoltage can be lowered without lowering the rate of utilization of the catalyst substance.

### (2) Second Preferred Embodiment

A second preferred embodiment for an electrode for a solid polymer fuel cell of the invention is similar to the first preferred embodiment, except that the average particle size of the catalyst substance A is larger than the average particle size of the catalyst substance B. That is, the catalyst substance B having a smaller particle size than the catalyst substance A carried on the electron conductive particles is dispersed in the ion conductive polymer, and the fuel gas activation point (catalyst activation point) is increased to enhance the rate of utilization of the catalyst substance. As a result, if the amount of the catalyst substance used is small on the whole, electric power can be obtained at high output and high efficiency.

In the embodiment, the average particle size of the catalyst substance A dispersed on the surface of the electron conductive particles is preferably 3 to 5 nm, more preferably 3.5 to 4.5 nm, and most preferably 3.8 to 4.2 nm. The average particle size of the catalyst substance B dispersed in the ion conductive polymer is preferably 0.1 to 2.5 nm, more preferably 0.5 to 2.0 nm, and most preferably 0.8 to 1.5 nm.

### (3) Third Preferred Embodiment

A third preferred embodiment for an electrode for a solid polymer fuel cell of the invention is similar to the second preferred embodiment, except that the catalyst substance B dispersed in the ion conductive polymer is prepared by once mixing a catalyst precursor substance in the ion conductive polymer, and then reducing the catalyst precursor substance chemically, and in that the catalyst precursor substance is a mixture of a basic compound and a nonbasic compound. That is, the catalyst precursor substance composed of a mixture of a basic compound and a nonbasic compound is mixed in the ion conductive polymer, and it is chemically reduced, and therefore a fine catalyst substance B can be precipitated and dispersed in the ion conductive polymer, and the rate of utilization of the catalyst substance is further increased, so that an electric power is obtained at higher output and higher efficiency.

It is a feature of this embodiment that the catalyst precursor substance as the material for the catalyst substance is a mixture of a basic compound and a nonbasic compound. By using a basic compound in the catalyst precursor substance, the viscosity of the ion conductive polymer is increased, and the ion conductive polymer is easier to aggregate. As the ion conductive polymer forms aggregates, the catalyst precursor substance hardly grows particles when the catalyst precursor substance is reduced, and hence a fine catalyst substance B is precipitated. However, if the amount of the basic compound is too great, the viscosity becomes too high, and the coating rate of the ion conductive polymer on the electron conductive particles decreases, and the catalyst activity point decreases, and the power generation performance declines. Accordingly by using a nonbasic compound together as the catalyst precursor substance, a desired catalyst substance amount may be obtained.

In the embodiment, the ion conductive polymer has a sulfone group, and when adding the basic compound, the ratio of the molar number of the hydroxyl group dissociated and generated from the basic compound/the molar number of the sulfone group is preferred to be in a range of 0.1 to 0.4 (10 to 40%). If this value exceeds 40%, the viscosity of the ion conductive polymer is too high, and the coating rate of the ion conductive polymer on the electron conductive particles is lowered; and if less than 10%, the particle size of the catalyst substance B is too large, and fine catalyst substance B is barely precipitated.

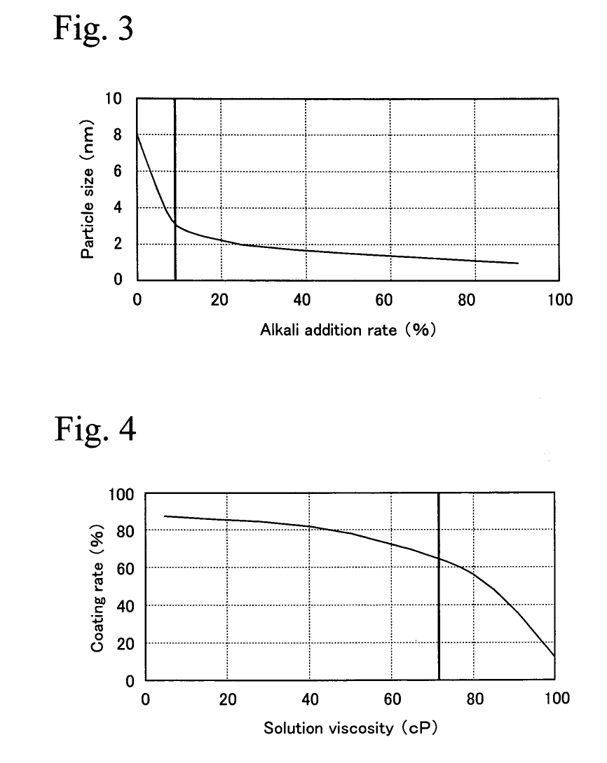

FIG. 2 shows an example of the relationship of the alkali (base) addition rate in the ion conductive polymer mixed with the catalyst precursor substance and the viscosity of the ion conductive polymer mixed with the catalyst precursor substance. FIG. 3 shows an example of the relationship between the alkali addition rate and the particle size of catalyst substance. According to FIG. 2, when the alkali addition rate is 40% or less, the viscosity is held at 70 cP or less. According to FIG. 3, when the alkali addition rate is less than 10%, the particle size of the catalyst substance increases suddenly, and at 10% or more, the particle size of the catalyst substance is fine and stable.

To precipitate and disperse the fine catalyst substance B in the ion conductive polymer, it may be considered to aggregate ion conductive polymer on the catalyst precursor substance in a mixture of ion conductive polymer, catalyst precursor substance, and solvent. That is, as mentioned above, as the ion conductive polymer aggregated on the catalyst precursor substance, particle growth of catalyst substance hardly occurs when the catalyst precursor substance is reduced, so that a fine catalyst substance B precipitates. A greater aggregation effect is obtained by raising to a relatively high level the viscosity of the ion conductive polymer mixed with the catalyst precursor substance; however, if the viscosity exceeds 70 cP, the coating rate of the ion conductive polymer on the electron conductive particles decreases, and the catalyst activity point decreases, and the power generation performance decreases. Therefore, the viscosity of the ion conductive polymer mixed with the catalyst precursor substance is preferred to be 70 cP or less.

FIG. 4 shows an example of coating rate of the ion conductive polymer on electron conductive particles by varying the viscosity of the ion conductive polymer mixed with the catalyst precursor substance, in which it is known that the viscosity of 70 cP or less should be required to maintain a relatively high coating rate (about 65%).

In this embodiment, preferably, the electron conductive particles dispersing the catalyst substance A should be coated with ion conductive polymer at a coating rate of 65% or more. The electron conductive particles having the catalyst substance A carried on the surface are covered with the ion conductive polymer on the surface of the gap portion of the catalyst substance A, but when the coating rate is less than 65%, the catalyst activity point decreases and the power generation efficiency decreases. Therefore, the coating rate is preferred to be 65% or more.

Also in this embodiment, the average particle size of the catalyst substance A dispersed on the surface of the electron conductive particles is preferred to be 3 to 5 nm, the same as in the second preferred embodiment, more preferably 3.5 to 4.5 nm, and most preferably 3.8 to 4.2 nm. The average particle size of the catalyst substance B dispersed in the ion conductive polymer is preferably 1 to 3 nm, and more preferably 1.5 to 2.5 nm.

### (4) Fourth Preferred Embodiment

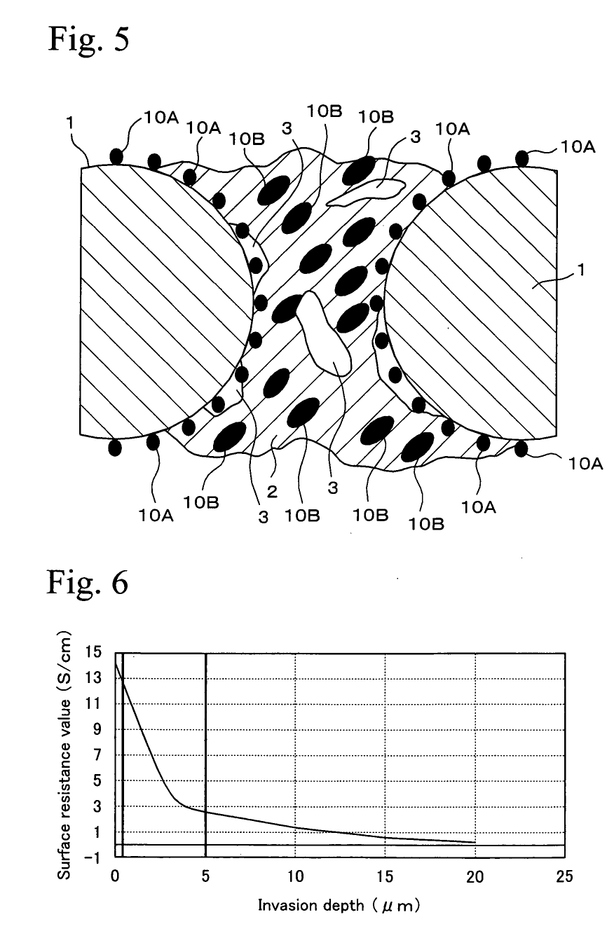

A fourth preferred embodiment for an electrode for a solid polymer fuel cell of the invention is similar to the first preferred embodiment, except that the average particle size of the catalyst substance B is larger than the average particle size of the catalyst substance A. That is, as shown in FIG. 5, the average particle size of a catalyst substance 10B dispersed in the ion conductive polymer 2 is larger than the average particle size of a catalyst substance 10A dispersed on the surface of the electron conductive particles 1. In this composition, particles of the catalyst substance 10B dispersed in the ion conductive polymer 2 approach each other to build up an electron conduction network, and therefore, if the amount of the catalyst substance used is small on the whole, an electric power can be obtained at high output and high efficiency.

In the embodiment, preferably, the catalyst substance B dispersed in the ion conductive polymer is scattered on the interface of the electrode for fuel cell and the laminated electrolyte membrane. In this mode, the distance between the catalyst substance B and the electrolyte membrane is short, and the conductivity of protons and electrons is activated, and the power generation performance is enhanced. That is, it yields the same effect as the action of enhancing the power generation effect by dispersing the catalyst substance B on the electrolyte membrane or in the electrolyte membrane. The scattering region of the catalyst substance B (or the invasion depth as mentioned below) is preferred to be within 5 μm from the interface with the electrolyte membrane from the viewpoint of obtaining this effect. This scattering configuration is particularly preferred in the negative side electrode for generating protons and electrons by chemical reaction in the fuel gas.

Also in the embodiment, the surface resistance value of the contacting plane of the electrode for a fuel cell and the laminated electrolyte membrane is preferred to be 2.5 to 13.5 S/cm. In this case, if the surface resistance value exceeds 13.5 S/cm, the existing position of the catalyst substance B in the ion conductive polymer is too far from the interface with the electrolyte membrane, and the invasion depth is greater, and it is difficult to obtain the ion conductivity improving effect. In contrast, when the surface resistance value is smaller than 2.5 S/cm, the ion conductivity is impeded. On the other hand, on the side opposite to the side of the electrode contacting with the electrolyte membrane, that is, on the side not contacting with the electrolyte membrane, the surface resistance value is preferred to be less than 2.5 S/cm.

In the embodiment, the average particle size of the catalyst substance A dispersed on the surface of the electron conductive particles is preferred to be 3 to 5 nm, more preferably 3.5 to 4.5 nm, and most preferably 3.8 to 4.2 nm. The average particle size of the catalyst substance B dispersed in the ion conductive polymer is preferably 5 to 23 nm, and more preferably 14 to 23 nm. In this case, if the average particle size of the catalyst substance B exceeds 23 nm, it is difficult to form a three-phase interface effective for power generation. In contrast, if lower than 5 nm, the surface resistance increases and the ion conductivity decreases.

In order to control the distance of the catalyst substance B dispersed in the ion conductive polymer from the interface with the electrolyte membrane, that is, the invasion depth from the interface of the catalyst substance B so as to obtain a favorable ion conductivity, it is preferred to add at least one mixture selected from the group consisting of organic solvent, base and surface active agent soluble in purified water when mixing the catalyst precursor substance in the ion conductive polymer. For example, when an alkaline substance is used, at an addition rate of 10% or less, the catalyst substrate B can be scattered within 5 μm from the interface with the electrolyte membrane.

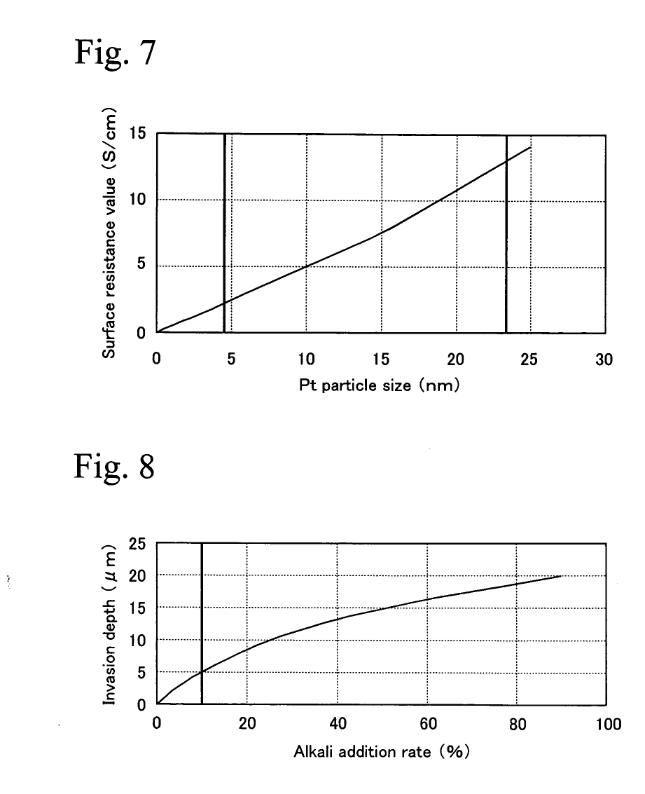

FIG. 6 is a diagram showing the relationship of invasion depth of catalyst substance B dispersed in ion conductive polymer and surface resistance value of the plane of the electrode contacting with an electrolyte membrane, and FIG. 7 is a diagram showing the relationship of particle size of Pt particles and surface resistance value when Pt particles are used as electron conductive particles. In FIG. 6, the conductivity is substantially enhanced at an invasion depth of less than 5 μm. As is clear from FIG. 7, in the Pt particle size in a range of about 5 to 23 nm, the surface resistance value is maintained in a range of 2.5 to 13.5 S/cm. FIG. 8 is a diagram showing the invasion depth of catalyst substance B by varying the alkali addition rate in ion conductive polymer mixed with catalyst precursor substance, in which at the alkali addition rate of 10%, the catalyst substance B is scattered within 5 μm from the interface with the electrolyte membrane.

### (5) Fifth Preferred Embodiment

A fifth preferred embodiment for an electrode for a solid polymer fuel cell of the invention is similar to the first preferred embodiment, except that the catalyst substance B has two kinds of average particle size. That is, by dispersing two kinds of catalyst substances differing in average particle size in the ion conductive polymer, the fuel gas activating point (catalyst activity point) is increased, and the rate of utilization of the catalyst substance is enhanced. Therefore, if the amount of the catalyst substances used is small on the whole, an electric power is obtained at high output and high efficiency.

### (6) Manufacturing Method for an Electrode for a Solid Polymer Fuel Cell

The electrode for a fuel cell of the invention can be manufactured in the following manner. First, electron conductive particles having a catalyst substance carried on the surface and ion conductive polymer are mixed, and this mixture is treated in a solution containing a catalyst substance to exchange ions. For example, when the ion conductive polymer has a sulfone group, the proton of the sulfone group is replaced by a cation containing a catalyst substance. Next, the mixture after ion exchange is exposed to a reducing atmosphere, so that a fine catalyst substance may be dispersed in the ion conductive substance.

Reducing methods may be roughly classified into a vapor phase method (dry process) using reducing gas such as hydrogen and carbon monoxide, and a liquid phase method (wet process) using NaBH₄, formaldehyde, glucose, hydrazine, etc. Either reducing method may be employed in the invention, but the liquid phase method is preferred. The reason for this is that by reduction in the liquid phase method, all catalyst metal ions in the ion conductive polymer are reduced, so that the catalyst substance may be uniformly dispersed in the ion conductive polymer.

Herein, the fabrication of electrode paste, fabrication of electrode sheets, ion exchange, and reduction can be executed in various sequences. For example, electron conductive particles having a catalyst substance carried on the surface, and ion conductive polymer are mixed to prepare an electrode paste, and this electrode paste is formed into a sheet, and ions are exchanged.

Alternatively, an electrode paste may be directly ion exchanged, and then an electrode sheet can be fabricated. Otherwise, an electrode paste is dried, solidified, and ground, and is ion exchanged in a powdered state, and then a paste is formed and an electrode sheet is fabricated. Alternatively, after fabricating the paste, it may be processed by ion exchange and reduction. In these manufacturing methods, the reducing step of catalyst metal ions may be executed either before or after fabrication of the electrode sheet. To form a sheet from an electrode paste, any known manufacturing method may be employed, such as a method of applying on a film for peeling the electrode paste after fabrication of the membrane-electrode compound, and a method of applying the electrode paste on carbon paper or electrolyte membrane.

For ion exchange, when the catalyst metal is platinum, a solution of Pt(NH₃)₄(OH)₂, Pt(NH₃)₄Cl₂, or PtCl₄ may be used. Catalyst metal ions to be ion exchanged may be complex ions such as Pt(NH₃)₄²⁺, in addition to metal ions such as Pt⁺. Without ion exchange, however, the catalyst substance can be dispersed in the ion conductive polymer. For example, by mixing Pt(NH₃)₂(NO₂)₂, H₂PtCl₆, H₂Pt(OH)₆, etc., well with ion conductive polymer, and then reducing the catalyst metal ion, a polymer electrolyte containing catalyst may be obtained. Alternatively, after ion exchange or after reduction, it is desired to perform cleaning to remove undesired components other than catalyst metal ions contained in the solution. Catalyst metal ions are not limited to catalyst metal ions, but may include other ions containing catalyst substance such as complex ion.

Methods of dispersing catalyst substance B in the ion conductive polymer include a method of mixing a catalyst precursor substance in the ion conductive polymer, without performing ion exchange, and reducing the catalyst precursor substance chemically to precipitate the catalyst substance B. This method is preferred because a fine catalyst substance is precipitated in the ion conductive polymer.

An example of manufacturing an electrode for a solid polymer fuel cell of the invention using this catalyst precursor substance is a manufacturing method comprising:

(a) a step of preparing electron conductive particles carrying catalyst substance and ion conductive polymer, and mixing a catalyst precursor substance therein to fabricate a catalyst paste,

(b) a step of applying this catalyst paste on an FEP (tetrafluoroethylene-hexafluoropropylene copolymer) sheet, and drying to form an electrode catalyst layer, and

(c) a step of reducing this catalyst precursor substance to disperse and precipitate the catalyst substance in the ion conductive polymer.

Catalyst substances usable in this manufacturing example include those derived from the electron conductive particles carrying the catalyst substance, and those dispersed and precipitated in the ion conductive polymer by reducing the catalyst precursor substance. Thus, by introducing the catalyst substance in the electrode catalyst layer at different steps, (a) and (b), the electrode of the invention is obtained. Step (c) may be executed two or more times, and in such a case, preferably, conditions of reduction should be changed.

In the invention, instead of step (a), preliminarily, the catalyst substance A is dispersed on the surface of the electron conductive particles, and the ion conductive polymer and catalyst precursor substance are mixed therewith. That is, before mixing the catalyst precursor substance in the ion conductive polymer, the catalyst substance A is dispersed on the surface of the electron conductive particles. As a result, it is easier to manufacture the electrode of the invention. Electron conductive particles having the catalyst substance A dispersed on the surface are, for example, carbon particles carrying platinum.

In a manufacturing method of the fifth preferred embodiment of the invention for the electrode for a solid polymer fuel cell of the invention, however, the following special method is employed. In this manufacturing method, at the mixing and reducing step of catalyst precursor substance in the first stage, the catalyst substance is precipitated in the ion conductive polymer, and at the mixing and reducing step for the catalyst substance in the second stage, the catalyst substance precipitated in the first stage is grown, and other new catalyst substance is precipitated in the ion conductive polymer. Therefore, two kinds of catalyst substance, differing in average particle size, can be precipitated and dispersed in the ion conductive polymer.

In a specific example of this manufacturing method, as electrode compositions, a first electrode composition and a second electrode composition are prepared, and the first electrode composition contains electron conductive particles, and after reducing the catalyst precursor substance in the first electrode composition (first stage), the second electrode composition is mixed in the first electrode composition, and then the catalyst precursor substance in the second electrode composition is reduced (second stage).

In this method, in the first stage of reducing the catalyst precursor substance in the first electrode composition, the catalyst substance can be precipitated on the surface of the conductive particles or in the vicinity thereof. In the second stage, other new catalyst substance is precipitated in the ion conductive polymer, and the catalyst substance precipitated in the first stage is easy to grow in the second stage, and a relative large catalyst substance grows around the electron conductive particles, while a relatively small catalyst substance is dispersed in the ion conductive polymer.

### EXAMPLES

The invention will be more specifically explained by referring to the following exemplary embodiments.

### (1) First Preferred Embodiment

<Sample 1>

A catalyst paste was prepared by mixing 100 g of ion conductive polymer (Nafion SE5112 of Du Pont Kabushiki Kaisha), 10 g of platinum carrying carbon particles of carbon black and platinum at a ratio by weight of 50:50 (TEC10E50E of Tanaka Kikinzoku Kogyo K.K.), and 5 g of glycerin (Kanto Kagaku). The catalyst paste was applied on a sheet of FEP (tetrafluroethylene-hexafluoropropylene copolymer), and was dried. The loading of platinum at this time was 0.32 mg/cm².

The obtained electrode sheet was immersed in an aqueous solution of Pt(NH₃)₄(OH)₂ to exchange ions, and then it was reduced by immersing in an aqueous solution of NaBH₄. The amount of platinum at this time was 0.34 mg/cm², together with the above platinum. The electrode sheet was cleaned in nitric acid and water, and was dried at 100° C. This cleaning is intended to remove undesired components other than platinum contained in the aqueous solution. The electrode sheet was transferred to both sides of the polymer electrolyte membrane (Nafion) by a decal method, and a membrane electrode assembly (MEA) was obtained. The transfer by a decal method is to bond the electrode sheet to the polymer electrolyte membrane by heat, and then to peel off the FEP sheet.

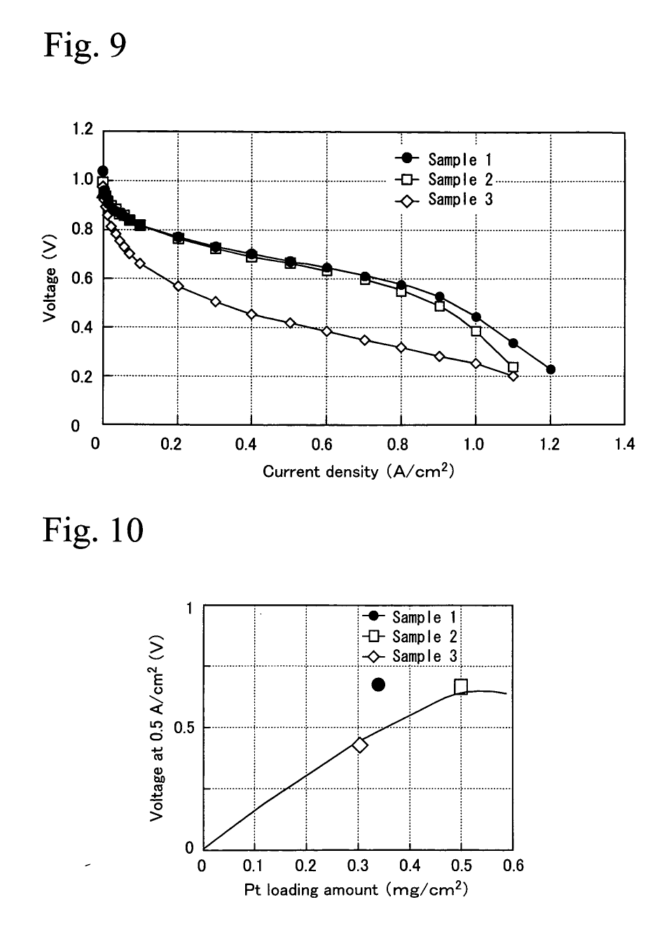

On both sides of the obtained membrane electrode assembly, hydrogen gas and air were supplied, and power was generated. The temperature of both hydrogen gas and air was 80° C. At this time, the rate of utilization (consumption/supply) of hydrogen gas was 50%, and the rate of utilization of air was 50%. The humidity of hydrogen gas was 50% RH, and the humidity of air was 50% RH. The relationship between the current density and voltage in this power generation is shown in FIG. 9.

<Samples 2 and 3>

Membrane electrode assemblies were prepared in the same way as in sample 1, except that the platinum was supplied only by platinum carrying Pt carbon particles without ion exchange of Pt, and that the loading of platinum was 0.3 mg/cm² and 0.5 mg/cm², and samples 2 and 3 for comparison were obtained. In the prepared membrane electrode assemblies, the power was generated in the same condition as in sample 1. The relationship between the current density and voltage in this power generation is also shown in FIG. 9.

As is clear from FIG. 9, in sample 1, regardless of the smaller loading of platinum than in sample 2 for comparison, the voltage was higher, and was particularly higher when compared with sample 3. Therefore, it was confirmed that a higher power generation efficiency can be obtained in this embodiment by a small amount of catalyst substance.

FIG. 10 shows the relationship between the platinum loading and the voltage at the current density of 0.5 A/cm² in samples 1 to 3. As shown in FIG. 10, in sample 1, by adding platinum at 0.02 mg/cm² by ion exchange, the voltage is much higher than in samples 2 and 3 provided with platinum only by platinum carrying carbon particles.

### (2) Second Preferred Embodiment

<Sample 4>

A catalyst paste was prepared by mixing 100 g of ion conductive polymer (Nafion SE5112 of Du Pont Kabushiki Kaisha), 10 g of platinum carrying carbon particles of carbon black and platinum at a ratio by weight of 50:50 (TEC10E50E of Tanaka Kikinzoku Kogyo K.K.), 10 g of platinum chloride acid aqueous solution as catalyst precursor substance (platinum 5% by weight), and 10 g of 0.01 normal ammonia aqueous solution. The catalyst paste was applied on a sheet of FEP by 0.26 mg/cm², and was dried. The obtained electrode sheet was immersed in an aqueous solution of Pt(NH₃)₄(OH)₂ to exchange ions, and then it was reduced by immersing in an aqueous solution of NaBH₄. The electrode sheet was cleaned in nitric acid and water to remove undesired components other than platinum contained in the aqueous solution, and was dried at 100° C., and an electrode sheet of sample 4 was obtained. The platinum loading in this electrode sheet was 0.3 mg/cm².

<Sample 5>

An electrode sheet of sample 5 was obtained in the same manner as in sample 4, except that the addition amount of the ammonia aqueous solution was 20 g.

<Sample 6>

An electrode sheet of sample 6 was obtained in the same manner as in sample 4, except that ammonia aqueous solution was not added.

<Sample 7>

An electrode sheet of sample 7 was obtained in the same manner as in sample 4, except that the addition amount of the ammonia aqueous solution was 50 g.

<Sample 8>

An electrode sheet of sample 8 for comparison was obtained in the same manner as in sample 4, except that the platinum was supplied by platinum carrying carbon particles only without ion exchange. The loading of platinum was 0.34 mg/cm².

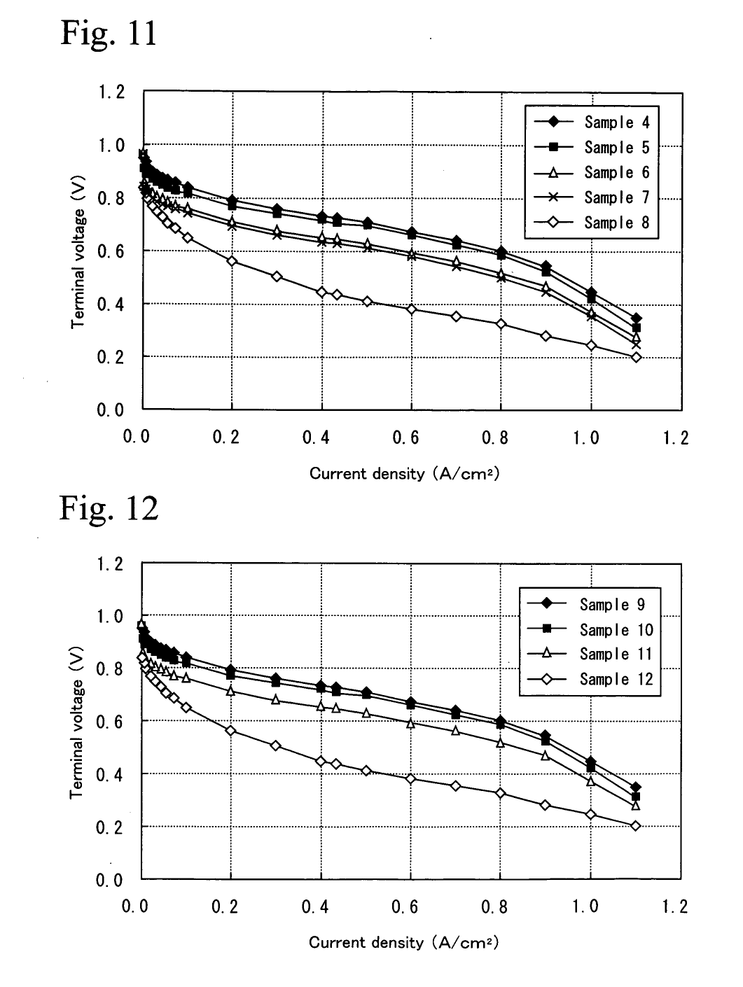

The electrode sheets of samples 4 to 8 were transferred to both sides of the polymer electrolyte membrane (Nafion) by a decal method, and membrane electrode assemblies (MEA) of samples 4 to 8 were obtained. On both sides of the obtained membrane electrode assembly, hydrogen gas and air were supplied, and power was generated. The temperature of both hydrogen gas and air was 80° C. At this time, the rate of utilization (consumption/supply) of hydrogen gas was 50%, and the rate of utilization of air was 50%. The humidity of hydrogen gas was 50% RH, and the humidity of air was 50% RH. The relationship between the current density and voltage in this power generation is shown in FIG. 11.

As is clear from FIG. 11, in samples 4 to 7, regardless of the same loading of platinum as in sample 8 for comparison, the voltage was higher, and therefore, it was confirmed that a higher power generation efficiency can be obtained by a small amount of catalyst substance.

### (3) Third Preferred Embodiment

<Sample 9>

A catalyst paste was prepared by mixing 100 g of ion conductive polymer (Nafion SE5112 of Du Pont Kabushiki Kaisha), 10 g of platinum carrying carbon particles of carbon black and platinum at a ratio by weight of 50:50 (TEC10E50E of Tanaka Kikinzoku Kogyo K.K.), and catalyst precursor substances comprising 9 g of Pt(NH₃)₂(NO₂)₂ aqueous solution (platinum 5% by weight; nonbasic compound) and 1 g of Pt(NH₃)₄(OH)₂ aqueous solution (platinum 5% by weight; basic compound). The catalyst paste was applied on a sheet of FEP (tetrafluroethylene-hexafluoropropylene copolymer), and was dried, and an electrode sheet was obtained. The loading of Pt at this time was 0.3 mg/cm². This electrode sheet was immersed and reduced in an aqueous solution of NaBH₄. The electrode sheet was cleaned in nitric acid and water to remove undesired components other than platinum contained in the aqueous solution, and was dried at 100° C., and an electrode sheet of sample 9 was obtained.

<Sample 10>

An electrode sheet of sample 10 was obtained in the same manner as in sample 9, except that the addition amount of Pt(NH₃)₂(NO₂)₂ aqueous solution was 6 g and that the addition amount of Pt(NH₃)₄(OH)₂ aqueous solution was 1

<Sample 11>

An electrode sheet of sample 11 was obtained in the same manner as in sample 9, except that the addition amount of Pt(NH₃)₂(NO₂)₂ aqueous solution was 5 g and that the addition amount of Pt(NH₃)₄(OH)₂ aqueous solution was 5 g.

<Sample 12>

An electrode sheet of sample 12 for comparison was obtained in the same manner as in sample 9, except that the addition amount of Pt(NH₃)₂(NO₂)₂ aqueous solution was 10 g and that the Pt(NH₃)₄(OH)₂ aqueous solution was not added.

The electrode sheets of samples 9 to 12 were transferred to both sides of the polymer electrolyte membrane (Nafion) by a decal method, and membrane electrode assemblies (MEA) of samples 9 to 12 were obtained. On both sides of the obtained membrane electrode assembly, hydrogen gas and air were supplied, and power was generated. The temperature of both hydrogen gas and air was 80° C. At this time, the rate of utilization (consumption/supply) of hydrogen gas was 50%, and the rate of utilization of air was 50%. The humidity of hydrogen gas was 50% RH, and the humidity of air was 50% RH. The relationship between the current density and voltage in this power generation is shown in FIG. 12.

As is clear from FIG. 12, in samples 9 to 11 mixing the basic compound and nonbasic compound as catalyst precursor substance, as compared with sample 12 for comparison mixing only the basic compound, the voltage was higher and a higher power generation efficiency was confirmed.

### (4) Fourth Preferred Embodiment

<Sample 13>

A catalyst paste was prepared by mixing 100 g of ion conductive polymer (Nafion SE5112 of Du Pont Kabushiki Kaisha), and 10 g of platinum carrying carbon particles of carbon black and platinum at a ratio by weight of 50:50 (TEC10E50E of Tanaka Kikinzoku Kogyo K.K.). This catalyst paste was applied on a sheet of FEP by 0.28 mg/cm², and was dried, and an electrode sheet was obtained. This electrode sheet was immersed and ion exchanged in an aqueous solution of Pt(NH₃)₄(OH)₂ adding 5% of ammonia aqueous solution, and it was then reduced by immersing in an aqueous solution of NaBH₄. The electrode sheet was cleaned in nitric acid and water to remove undesired components other than platinum contained in the aqueous solution, and was dried at 100° C., and an electrode sheet of sample 13 was obtained.

<Sample 14>

An electrode sheet of sample 14 was obtained in the same manner as in sample 13, except that the content of ammonium aqueous solution was 10%.

<Sample 15>

An electrode sheet of sample 15 was obtained in the same manner as in sample 13, except that the content of ammonium aqueous solution was 15%.

<Sample 16>

An electrode sheet of sample 16 was obtained in the same manner as in sample 13, except that ammonium aqueous solution was not added.

<Sample 17>

An electrode sheet of sample 17 for comparison was obtained in the same manner as in sample 13, except that the platinum was supplied by platinum carrying carbon particles only without ion exchange. The loading of platinum was 0.34 mg/cm².

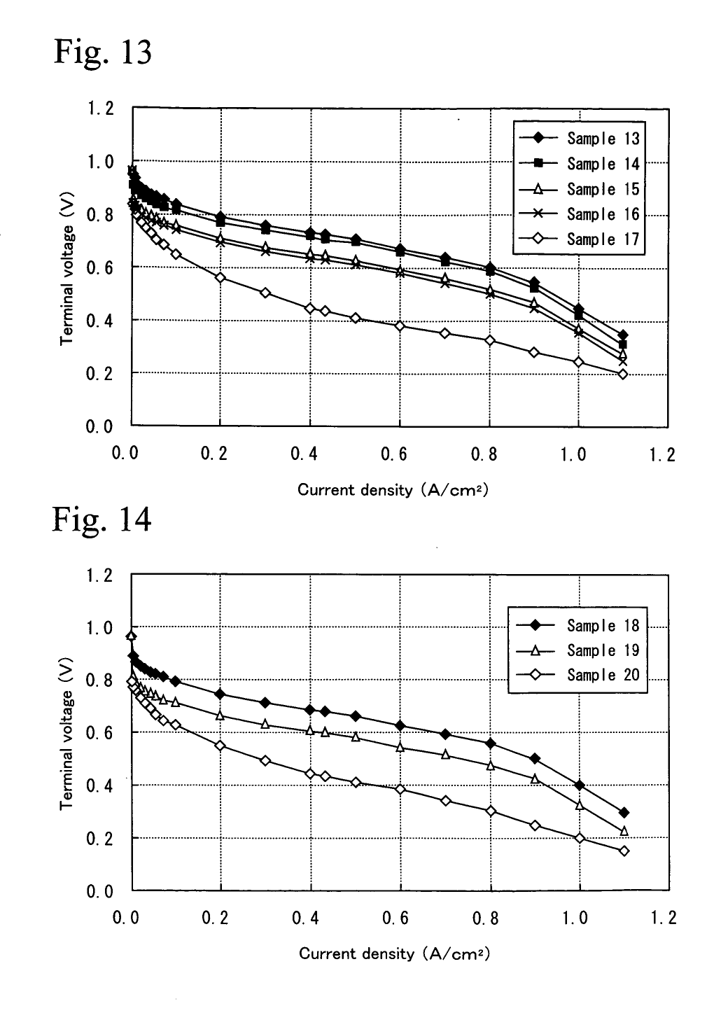

The electrode sheets of samples 13 to 17 were transferred to both sides of the polymer electrolyte membrane (Nafion) by a decal method, and membrane electrode assemblies (MEA) of samples 13 to 17 were obtained. On both sides of the obtained membrane electrode assembly, hydrogen gas and air were supplied, and power was generated. The temperature of both hydrogen gas and air was 80° C. At this time, the rate of utilization (consumption/supply) of hydrogen gas was 50%, and the rate of utilization of air was 50%. The humidity of hydrogen gas was 50% RH, and the humidity of air was 50% RH. The relationship between the current density and voltage in this power generation is shown in FIG. 13.

As is clear from FIG. 13, in samples 13 to 16, in spite of the smaller amount of platinum than in sample 17 for comparison, the voltage was higher and a higher power generation efficiency was confirmed in spite of the smaller content of catalyst compound.

### (5) Fifth Preferred Embodiment

<Sample 18>

A catalyst paste was prepared by mixing 50 g of ion conductive polymer (Nafion SE5112 of Du Pont Kabushiki Kaisha), 8 g of carbon particles (Ketienblack of Cabot), and 40 g of platinum chloride acid aqueous solution (platinum 5% by weight). This catalyst paste was immersed and reduced in an aqueous solution of NaBH₄, and a catalyst paste A (first electrode composition) was obtained. On the other hand, a catalyst paste B (second electrode composition) was prepared by mixing 30 g of ion conductive polymer (Nafion SE5112 of Du Pont Kabushiki Kaisha), 10 g of platinum chloride acid aqueous solution (platinum 5 wt. %), and 9 g of 0.01 normal ammonia aqueous solution.

The catalyst pastes A and B were mixed, and were further immersed and reduced in an aqueous solution of NaBH₄. The reduced catalyst paste was applied on a sheet of FEP (tetrafluroethylene-hexafluoropropylene copolymer), and was dried, and an electrode sheet was obtained. The loading of platinum at this time was 0.2 mg/cm². This electrode sheet was cleaned in nitric acid and water, and was dried at 100° C., and an electrode sheet of sample 18 was obtained.

<Sample 19>

An electrode sheet of sample 19 was obtained in the same manner as in sample 18, except that ammonia aqueous solution was not added when preparing catalyst paste B.

<Sample 20>

A catalyst paste was prepared by mixing 100 g of ion conductive polymer (Nafion SE5112 of Du Pont Kabushiki Kaisha), and 10 g of platinum carrying carbon particles of carbon black and platinum at a ratio by weight of 50:50 (TEC10E50E of Tanaka Kikinzoku Kogyo K.K.). This catalyst paste was applied on a sheet of FEP, and was dried, and an electrode sheet was obtained. The loading of platinum at this time was 0.2 mg/cm². This electrode sheet was cleaned in nitric acid and water, and was dried at 100° C., and an electrode sheet of sample for comparison 20 was obtained.

The electrode sheets of samples 18 to 20 were transferred to both sides of the polymer electrolyte membrane (Nafion) by a decal method, and membrane electrode assemblies (MEA) of samples 18 to 20 were obtained. On both sides of the obtained membrane electrode assembly, hydrogen gas and air were supplied, and power was generated. The temperature of both hydrogen gas and air was 80° C. At this time, the rate of utilization (consumption/supply) of hydrogen gas was 50%, and the rate of utilization of air was 50%. The humidity of hydrogen gas was 50% RH, and the humidity of air was 50% RH. The relationship between the current density and voltage in this power generation is shown in FIG. 14.

As is clear from FIG. 14, in samples 18 and 19, in spite of the same amount of platinum being used as in sample 20 for comparison, the voltage was higher and a higher power generation efficiency was confirmed, without increasing the content of the catalyst compound.

What is claimed is:

1. A manufacturing method for an electrode for a solid polymer fuel cell comprising
a step of preparing an electrode paste by mixing electron conductive particles having catalyst particles carried on the surface and an ion conductive polymer,
a step of ion-exchanging the ion conductive polymer by treating the electrode paste or an electrode sheet prepared from the electrode paste in a solution containing catalyst metal ions, so as to exchange cation in the ion conductive polymer for the catalyst metal ion, and
a step of reducing the catalyst metal ions by a liquid phase method.

2. The manufacturing method for an electrode for a solid polymer fuel cell of claim 1, wherein the electrode sheet is prepared from the electrode paste, and then it is ion-exchanged.

3. The manufacturing method for an electrode for a solid polymer fuel cell of claim 1, wherein the electrode paste is ion-exchanged, and then an electrode sheet is fabricated.

4. The manufacturing method for an electrode for a solid polymer fuel cell of claim 1, wherein the electrode paste is dried, solidified and ground, and it is ion-exchanged in a powdered state, and then an electrode sheet is fabricated.

5. The manufacturing method for an electrode for a solid polymer fuel cell of claim 1, wherein the liquid phase method is carried out using NaBH₄, formaldehyde, glucose, or hydrazine.

6. A manufacturing method for an electrode for a solid polymer fuel cell comprising
a step of preparing an electrode composition composed at least of ion conductive polymer and catalyst precursor substance,
a step of reducing the catalyst precursor substance to precipitate a catalyst substance by a liquid phase method, and
a step of forming this electrode composition into a sheet, Wherein the catalyst precursor substance is mixed and reduced by dividing into two steps.

7. The manufacturing method for an electrode for a solid polymer fuel cell of claim 6, wherein the electrode composition consists of a first electrode composition containing electron conductive particles and a second electrode composition, the reduction of the catalyst precursor substance comprises a step of reducing catalyst precursor substance in the first electrode composition, a step of mixing the second electrode composition with the first electrode composition, and a step of reducing catalyst precursor substance in the first electrode composition and the second electrode composition.

8. The manufacturing method for an electrode for a solid polymer fuel cell of claim 6, wherein the liquid phase method is carried out using NaBH₄, formaldehyde, glucose, or hydrazine.
